(19) United States
(12) Patent Application Publication
(10) Pub. No.: US 2025/0131911 A1
(43) Pub. Date: Apr. 24, 2025

(54) AUDIO DESCRIPTOR GENERATION MECHANISM

(71) Applicant: Hirdle, Somers, NY (US)

(72) Inventors: David Ouimette, Somers, NY (US); Taylor Ohlsen, Denver, CO (US)

(73) Assignee: Hirdle, Somers, NY (US)

(21) Appl. No.: 18/905,953

(22) Filed: Oct. 3, 2024

Related U.S. Application Data
(60) Provisional application No. 63/591,194, filed on Oct. 18, 2023.

(51) Int. Cl. G10L 13/08; G06F 16/955; H04L 65/60; H04L 67/06

(52) U.S. Cl. CPC G10L 13/08; G06F 16/9554; H04L 65/60; H04L 67/06

(57) ABSTRACT

A system is disclosed. The system includes one or more processing elements to execute descriptor generation logic to receive text data, generate a text file based on the text data, generate an audio file based on the text file and one or more voice preferences, generate a uniform resource locator (URL) associated with the audio file and generate a quick response (QR code) associated with the URL.

This application claims priority from Provisional U.S. Patent Application No. 63/591,194, filed Oct. 18, 2023, entitled Computer Process that Converts a Product's Written Data Content into a Unique URL and QR Code Linked Web Accessible Audio Files, which is incorporated herein by reference in its entirety and for all purposes.

### BACKGROUND

Text-to-speech (TTS) (or read aloud) technology comprises software that reads digital text aloud using a synthetic voice. TTS is useful for people with disabilities, such as low vision or eye strain, and can also be helpful for people who prefer to multitask while reading, or who have a learning style that is better suited to auditory or bimodal learning.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates one embodiment of a computing device employing an audio descriptor generation mechanism;

FIG. 2 illustrates one embodiment of an audio descriptor generation mechanism employed in a network;

FIG. 3 illustrates one embodiment of an audio descriptor generation mechanism;

FIG. 4 is a flow diagram illustrating one embodiment of a process for generating an audio product descriptor;

FIG. 5 is a flow diagram illustrating one embodiment of a process for accessing and playing an audio product descriptor file; and

FIG. 6 illustrates one embodiment of a computer system.

### DETAILED DESCRIPTION

As digital content consumption increasingly moves across multiple devices and platforms, there is a growing demand for TTS systems that offer timely, anytime and location independent access to synthesized speech audio files, optimized for the audience, from any text-based data sourced information. However, existing TTS systems lack the ability to dynamically adapt to different languages, accents, and user preferences in real-time. This limitation is particularly evident in multilingual environments where consistent speech quality and personalization are critical.

According to one embodiment, a mechanism is provided to generate TTS audio files from text-based formats that are uniquely coupled to and accessible from Uniform Resource Locators (URLs) and quick response codes (QR codes). In a further embodiment, a TTS file may be dynamically updated without having to update an associated URL and QR code.

Reference in the specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

As a preliminary note, the terms “logic,” “engine,” “component,” “module,” “system,” and the like as used herein are intended to refer to a computer-related entity, either software-executing general-purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

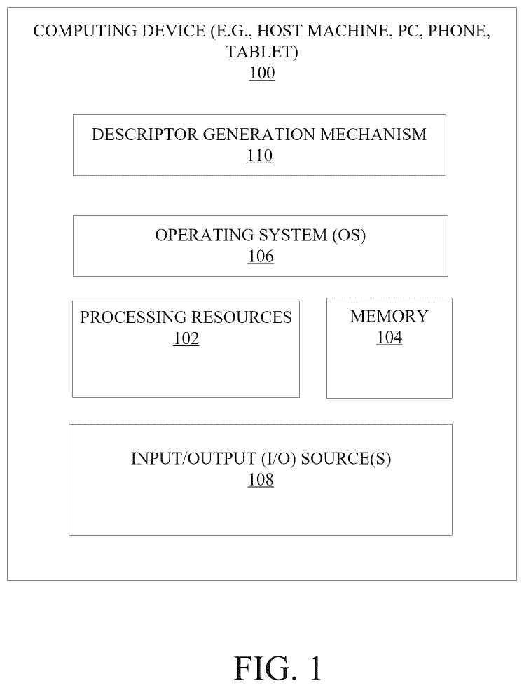

FIG. 1 illustrates a descriptor generation mechanism 110 at a computing device 100 according to one embodiment. In one embodiment, computing device 100 serves as a host machine for hosting audio descriptor generation mechanism (or descriptor generation mechanism) 110 that includes a combination of any number and type of components for facilitating content control at computing devices, such as computing device 100. In such an embodiment, computing device 100 includes a wireless computing device, such as a mobile computing device (e.g., smartphones, tablet computers, etc.). However, computing device may be implemented as server computing devices, cameras, PDAs, personal computing devices (e.g., desktop devices, laptop computers, etc.), smart televisions, servers, wearable devices, media players, any smart computing devices, and so forth. Embodiments, however, are not limited to these examples.

Computing device 100 may include an operating system (OS) 106 serving as an interface between hardware and/or physical resources of the computer device 100 and a user. Computing device 100 may further include one or more processing resources 102, memory devices 104, network devices, drivers, or the like, as well as input/output (I/O) sources 108, such as touchscreens, touch panels, touch pads, virtual or regular keyboards, virtual or regular mice, etc. In embodiments, a processing resource 102 may comprise hardware, such as a central processing unit (CPU) graphics processing unit (GPU), programmable device, etc. However in other embodiments, a processing resource 102 may comprise software (e.g., virtual machine or container).

According to one embodiment, descriptor generation mechanism 110 enables the generation of QR codes to access a TTS generated audio file. In such an embodiment, descriptor generation mechanism 110 receives text data, processes the text and generates audible speech from the processed text. In a further embodiment, an associated URL and QR code is generated to facilitate accessing the TTS file.

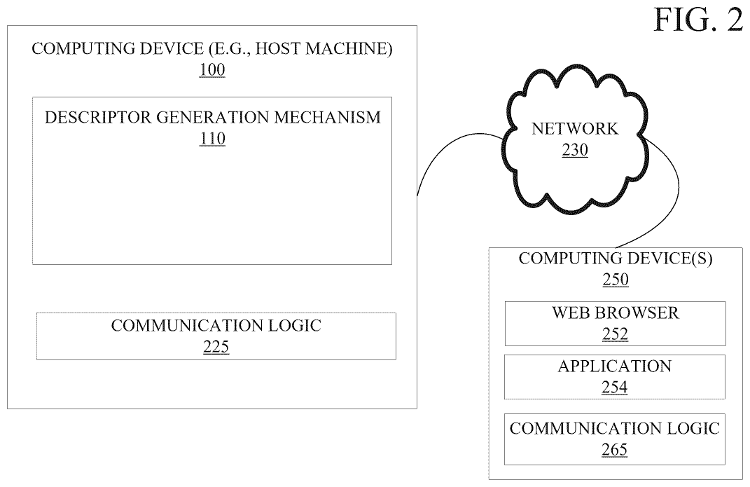

FIG. 2 illustrates one embodiment of a descriptor generation mechanism 110 employed at computing device 100 within a network environment. In one embodiment, descriptor generation mechanism 110 communicates with one or more client computing devices 250 via a network 230. In this embodiment, communication logic 225 may be used to facilitate dynamic communication and compatibility between various computing devices 250 (e.g., via a cloud network, the Internet, intranet, cellular network, proximity or near proximity networks, etc.). Computing device 250 may also include communication logic 265 to communicate with communication logic 225. Communication logic 265 may be similar to, or the same, as communication logic 225 of computing device 100 and may be used to facilitate communication with descriptor generation mechanism 110 at computing device 100 over network 230, as will be discussed in more detail below.

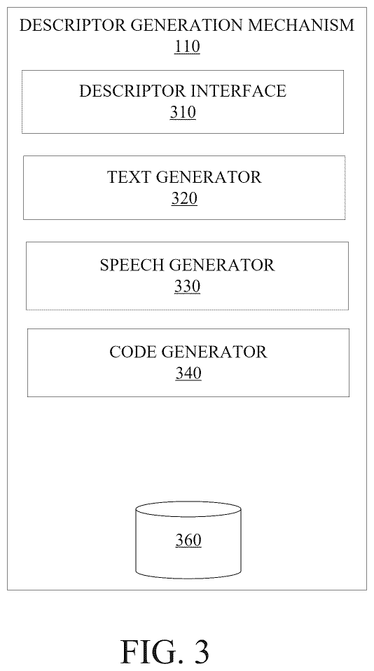

FIG. 3 illustrates one embodiment of descriptor generation mechanism 110. As shown in FIG. 3, descriptor generation mechanism 110 includes descriptor interface 310, text generator 320, speech generator 330, code generator 340 and database 360. Descriptor interface 310 comprises an application program interface (API) that facilitates access to text-based data content (e.g., product/item descriptions, product instructions and unique product identifiers) that may be received from an external source (e.g., a third-party server). In a further embodiment, descriptor interface 310 also comprises a user interface to enable the text-based data content to be entered by a user. The user interface component of descriptor interface 310 may also be implemented to specify various settings (e.g., message tone, message structure, etc.). In this embodiment, a product vendor may customize the settings.

According to a preferred embodiment, the text-based data content comprises a medical prescription including the prescription details (e.g., a prescription unique identifier, patient name, drug name, start date, end date, dosage instructions, drug interactions and warnings). In such an embodiment, text generator 320 receives the text-based data content and generates a text-based message based on the text-based data content and the specified settings. Text generator 320 may comprise an artificial intelligence (AI) model to generate the structure of the message. For example, the AI model may automatically detect the language, accent, and dialect of the input text and optimizes the text for speech synthesis. The AI model also includes contextual analysis submodule to interpret the context, adjusting pronunciation, intonation, and tone accordingly. In a further embodiment, descriptor interface 310 may be implemented to review, edit and/or accept the generated text-based message.

Speech generator 330 generates audible speech in the form of a voice audio file (or audio file) based on the text-based message and one or more voice preferences. In one embodiment, descriptor interface 310 may be used to select voice preferences for the generated audio file. For example, descriptor interface 310 may select a language, gender, accent, sentiment and cadence that will provide instructions for the generation of the audio file. In the pharmacy embodiment, an individual user at computing device 250 may access a secure account at descriptor generation mechanism 110 to customize the voice preferences. In this embodiment, the voice preferences are included as preference data in a database record associated with a computing device 250 user. Speech generator 330 may implement natural language and large language models to generate the voice audio file to include user preferences and language specific nuances. Speech generator 330 performs speech optimization to enhance fluency, naturalness, and clarity.

Code generator 340 generates a secure URL associated with the audio file to enable the audio file to be accessed from a computing device 250. Additionally, code generator 340 generates a QR code directly associated with (or linked to) the URL. The audio file may be included in the associated database record and subsequently stored in database 360 under an index for the URL for later retrieval of the audio file upon the URL being accessed. In one embodiment, each database record comprises the following format:
ClientID (unique identifier for the record);
UserID (attaches to User Profile and User Preferences tables);
Creation Date (Datestamp);
Last Update (Datestamp);
Subject (user provided subject for the Client);
Text (user provided, user system provided or AI assisted text0;
Audio File (file name and directory to the audio file);
URL (URL that accesses the Audio file to be played); and
VoiceTag (QR code).

Although described as being included in computing system 100, database 360 may comprise cloud storage that securely stores the audio file, thus allowing instant access from any connected device. In a further embodiment, database 360 may be accessed via AI-driven indexing and retrieval mechanisms for quick access to stored audio files, with user-specific encryption to ensure data protection.

According to one embodiment, the QR code may be placed on a product label and used to retrieve an audio file via the associated URL upon being accessed by an image capture device (e.g., camera) at a computing device 250. Using the pharmaceutical embodiment as an example, a label including the QR code may be generated and placed on the medication at a pharmacy once the QR code has been generated and the associated URL and audio file has been stored. In yet a further embodiment, the QR code may be embedded within the content of one or more websites.

According to one embodiment, the QR code and the audio file URL will remain the same throughout the lifecycle of a product. However, the audio file may be continuously updated if necessary. In this embodiment, a new text-based message may be generated upon the receipt of updated text-based data content associated with a product identifier. As a result, an updated audio file is generated based on the updated text-based data content and the currently selected voice preferences. The updated audio file is subsequently stored in database 360 in the data record associated with the computing device 250 user. In one embodiment, the associated data record is updated by replacing the previous audio file with the updated audio file.

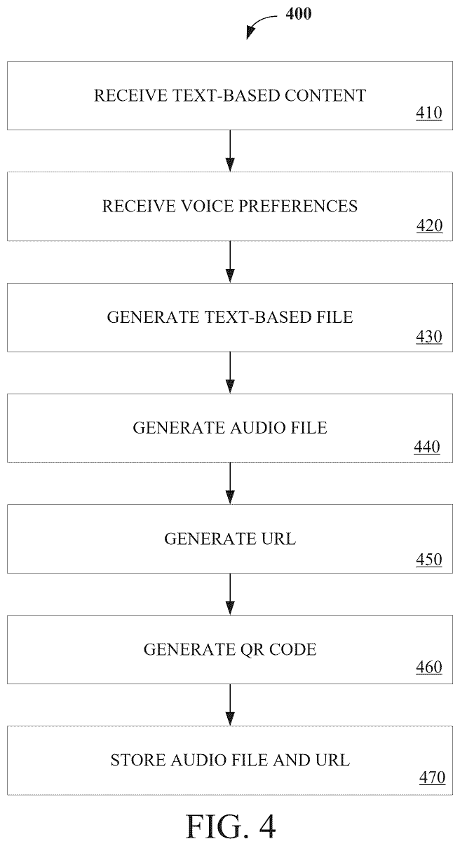

FIG. 4 is a flow diagram illustrating one embodiment of a process 400 for generating a product descriptor. Process 400 may be performed by processing logic that may comprise hardware (e.g., circuitry, dedicated logic, programmable logic, etc.), software (such as instructions run on a processing device), or a combination thereof. In one embodiment, processes 400 may be performed by descriptor generation mechanism 110. Process 400 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-3 are not discussed or repeated here.

At processing block 410, text-based content is received. At processing block 420, voice preferences are received. As discussed above, language, gender, accent, sentiment and cadence voice preferences may be selected via a user interface. At processing block 430, a text-based file is generated based on the text-based content. At processing block 440, an audio file is generated based on the text-based file and the voice preferences. At processing block 450, a URL associated with the audio file is generated. At processing block 460, a QR code associated with the URL is generated. At processing block 470, the audio file is stored with the URL, product identifier and user identifier for later retrieval. As discussed above, the audio file may be dynamically updated (e.g., by updating the text-based file and/or preferences) without the URL and QR code having to be changed.

A computing device 250 can access the audio file once the associated QR code is placed on a product or embedded in a digital environment (e.g., website). In one embodiment, a web browser 252 at computing device acquires the URL upon an image capture of the QR code and translates the QR code into the associated URL. Subsequently, web browser 252 uses the URL to access the data file in database 360 at computing device 100 using the product identifier and user identifier associated with the URL. In one embodiment, computing device 100 includes an audio player (not shown) to transmit the content of the audio file as streaming audio data of the contents of the audio file for consumption by the computing device 250 user. However in other embodiments, computing device 100 may transmit the audio file to computing device 250 for playback. In yet a further embodiment, computing device 250 may include a descriptor generation application that, instead of browser 252, accesses the data file upon scanning of the QR code.

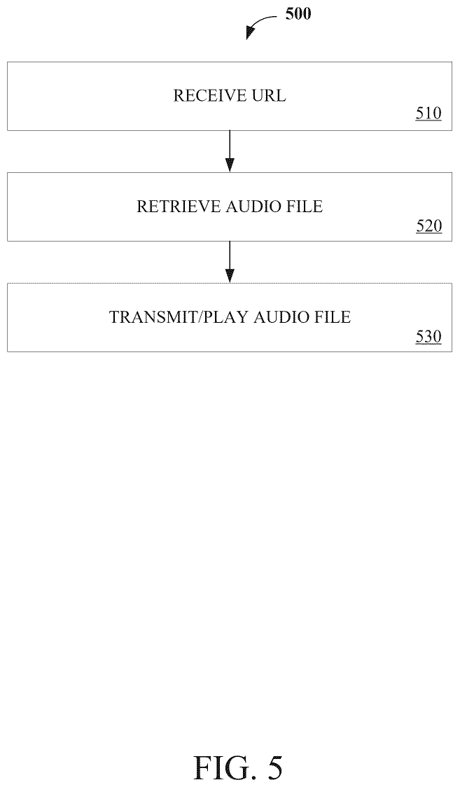

FIG. 5 is a flow diagram illustrating one embodiment of a process 500 for accessing and playing a product descriptor audio file. Process 500 may be performed by processing logic that may comprise hardware (e.g., circuitry, dedicated logic, programmable logic, etc.), software (such as instructions run on a processing device), or a combination thereof. In one embodiment, processes 500 may be performed by descriptor generation mechanism 110. Process 500 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-4 are not discussed or repeated here.

Process 500 begins at processing block 510, where a URL is received (e.g., in response to the associated QR code being scanned). At processing block 520, the audio file is retrieved from database 360 using the URL. At processing block 530, the audio file is streamed (or transmitted) to be played at computing device 250. Referring again to the pharmacy embodiment, process 500 occurs upon a computing device 250 user receiving a prescription and scanning the QR code to receive audio instructions (e.g., due to a vision disability), which results in the user instantaneously receiving the audio instructions.

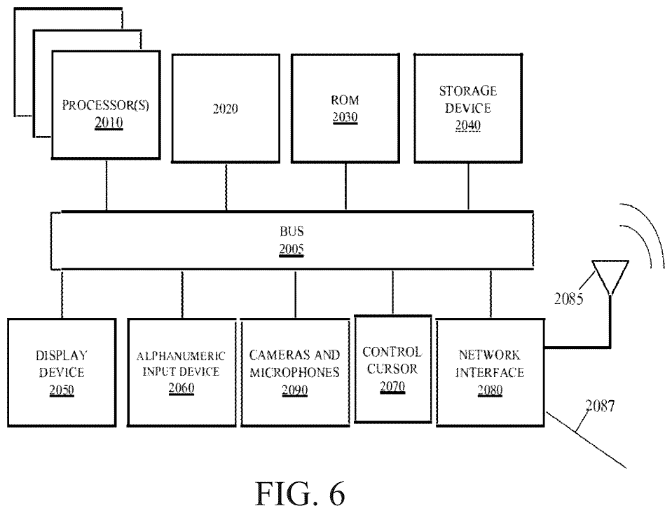

FIG. 6 illustrates one embodiment of a computer system 2000, which may be representative of computing device 100 and computing device 250. Computing system 2000 includes bus 2005 (or, for example, a link, an interconnect, or another type of communication device or interface to communicate information) and processor 2010 coupled to bus 2005 that may process information. While computing system 2000 is illustrated with a single processor, electronic system 2000 may include multiple processors and/or co-processors, such as one or more of central processors, graphics processors, and physics processors, etc. Computing system 2000 may further include random access memory (RAM) or other dynamic storage device 2020 (referred to as main memory), coupled to bus 2005 and may store information and instructions that may be executed by processor 2010. Main memory 2020 may also be used to store temporary variables or other intermediate information during execution of instructions by processor 2010.

Computing system 2000 may also include read only memory (ROM) and/or other storage device 2030 coupled to bus 2005 that may store static information and instructions for processor 2010. Date storage device 2040 may be coupled to bus 2005 to store information and instructions. Date storage device 2040, such as magnetic disk or optical disc and corresponding drive may be coupled to computing system 2000.

Computing system 2000 may also be coupled via bus 2005 to display device 2050, such as a cathode ray tube (CRT), liquid crystal display (LCD) or Organic Light Emitting Diode (OLED) array, to display information to a user. User input device 2060, including alphanumeric and other keys, may be coupled to bus 2005 to communicate information and command selections to processor 2010. Another type of user input device 2060 is cursor control 2070, such as a mouse, a trackball, a touchscreen, a touchpad, or cursor direction keys to communicate direction information and command selections to processor 2010 and to control cursor movement on display 2050. Camera and microphone arrays 2090 of computer system 2000 may be coupled to bus 2005 to observe gestures, record audio and video and to receive and transmit visual and audio commands.

Computing system 2000 may further include network interface(s) 2080 to provide access to a network, such as a local area network (LAN), a wide area network (WAN), a metropolitan area network (MAN), a personal area network (PAN), Bluetooth, a cloud network, a mobile network (e.g., 3rd Generation (3G), etc.), an intranet, the Internet, etc. Network interface(s) 2080 may include, for example, a wireless network interface having antenna 2085, which may represent one or more antenna (e). Network interface(s) 2080 may also include, for example, a wired network interface to communicate with remote devices via network cable 2087, which may be, for example, an Ethernet cable, a coaxial cable, a fiber optic cable, a serial cable, or a parallel cable.

Network interface(s) 2080 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 2080 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 2080 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 2000 may vary from implementation to implementation depending upon numerous factors, such as price constraints, performance requirements, technological improvements, or other circumstances. Examples of the electronic device or computer system 2000 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a printed circuit board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements cooperate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A system comprising one or more processing elements to execute descriptor generation logic to receive text data, generate a text file based on the text data, generate an audio file based on the text file and one or more voice preferences, generate a uniform resource locator (URL) associated with the audio file and generate a quick response (QR code) associated with the URL.

2. The system of claim 1, wherein the descriptor generation logic further to store the URL and the QR code.

3. The system of claim 2, wherein the descriptor generation logic further to receive the URL from a client computing coupled via a network and retrieve the associated audio file.

4. The system of claim 3, wherein the URL is received in response to the QR code being accessed at the client computing device.

5. The system of claim 3, wherein the descriptor generation logic further to transmit the audio file to the client computing device.

6. The system of claim 3, wherein the descriptor generation logic further to transmit streaming audio data of contents of the audio file to the client computing device.

7. The system of claim 1, wherein the descriptor generation logic further to receive a second text data, generate a second text file based on the second text data, generate a second audio file based on the second text file and associate the second audio file with the URL.

8. The system of claim 1, wherein the one or more preferences comprise instructions for the generation of the audio file.

9. The system of claim 8, wherein the one or more preferences comprise at least one of a language, gender, accent, sentiment and cadence.

10. A method comprising:
receiving text data;
generating a text file based on the text data;
generating an audio file based on the text file and one or more voice preferences;
generating a uniform resource locator (URL) associated with the audio file; and
generating a quick response (QR code) associated with the URL.

11. The method of claim 1, further comprising storing the URL and the QR code.

12. The method of claim 11, further comprising:
receiving the URL from a client computing coupled via a network; and
retrieving the associated audio file.

13. The method of claim 12, wherein the URL is received in response to the QR code being accessed at the client computing device.

14. The method of claim 12, further comprising transmitting the audio file to the client computing device.

15. The method of claim 12, further comprising transmitting streaming audio data of contents of the audio file to the client computing device.

16. At least one non-transitory computer readable medium having instructions stored thereon, which when executed by one or more processors, cause the processors to:
receive text data;
generate a text file based on the text data;
generate an audio file based on the text file and one or more voice preferences;
generate a uniform resource locator (URL) associated with the audio file; and
generate a quick response (QR code) associated with the URL.

17. The computer readable medium of claim 16, having instructions stored thereon, which when executed by one or more processors, cause the processors to:
receive a second text data;
generate a second text file based on the second text data;
generate a second audio file based on the second text file; and
associate the second audio file with the URL.

18. The computer readable medium of claim 16, having instructions stored thereon, which when executed by one or more processors, cause the processors to:
receive the URL from a client computing coupled via a network; and
retrieve the associated audio file.

19. The computer readable medium of claim 18, having instructions stored thereon, which when executed by one or more processors, cause the processors to transmit the audio file to the client computing device.

20. The computer readable medium of claim 18, having instructions stored thereon, which when executed by one or more processors, cause the processors to transmit streaming audio data of contents of the audio file to the client computing device.
